(19) United States
(12) Patent Application Publication
(10) Pub. No.: US 2016/0153319 A1
(43) Pub. Date: Jun. 2, 2016

(54) TAPPET TIP GEOMETRY FOR A PRESSURE CONTROL VALVE

(71) Applicant: ROBERT BOSCH GMBH, Stuttgart (DE)

(72) Inventor: Elmar VIER, Freiberg A.N. (DE)

(21) Appl. No.: 14/903,929

(22) PCT Filed: Jul. 8, 2014
(86) PCT No.: PCT/EP2014/064622

§ 371 Date: Jan. 8, 2016

(30) Foreign Application Priority Data
Jul. 9, 2013 (DE) 10 2013 213 419.3

(51) Int. Cl. F01L 1/14; F16K 17/04

(52) U.S. Cl. CPC F01L 1/14; F16K 17/0406

(57) ABSTRACT

The invention relates to a tappet element (2), in particular for a pressure control valve (4), comprising a tappet body (2a), in particular an elongated tappet body. The tappet body has a first side (2b), a second side (2c), and a centre axis (2d). A tappet tip (14) is formed on the first side (2a), which tappet tip is designed to contact a valve ball (6). A driving device (10) for the tappet element (2) can be provided on the second side (2c). The tappet tip (14) has a recess (12) for contacting a valve ball (6). The tappet element is characterised in that the recess (12) has a first region (16a) and a second region (16b), the two regions (16a, b) being arranged concentrically with respect to the centre axis (2d); and a valve ball (6) being movable (18a) on the surface (22a) of the recess (12) substantially in a radial direction (20a) perpendicular to the centre axis (2d) in the first region (16a); and a valve ball (6) being movable (18b) on the surface (22b) of the recess (12) substantially in a combined motion both in the radial direction (20a) and in an axial direction (20b) in the second region (16b).

### BACKGROUND OF THE INVENTION

The present invention relates to engine technology for vehicles. The present invention relates particularly to pressure control valves for diesel fuel injection systems. The present invention furthermore relates to a novel tappet element or, respectively, to a novel tappet tip geometry for a pressure control valve.

Pressure control valves are used inter alia in engine technology within the scope of diesel engines for the direct injection of fuel. A pressure control valve is particularly used within the scope of common rail diesel systems. A high pressure pump thereby ensures the maintenance of a fuel pressure in a distributor pipe. A pressure control valve is then provided to adjust and maintain the pressure in the rail as a function of the target pressure predefined in the control device. For the most part, a valve ball is pressed by means of magnetic force into a valve seat in order to close the valve.

Pressure control valves (PCV) in diesel injection systems on the basis of a common rail are used to adjust and limit the rail pressure. The basic construction consists of a valve seat or, respectively, a valve body, which can be opened or closed by means of a spherical closing element. The valve ball is actuated by a valve tappet which is guided in the valve housing and is part of a magnetic circuit, wherein the actuating force of the valve tappet is generated by passing current through said magnetic circuit.

FIGS. 1a, b depict the schematic design of a conventional pressure control valve.

The pressure control valve 4 comprises a tappet element which has a tappet tip 14 on a first side 2b, said tappet tip pressing a valve ball 6 into a valve seat 24 and thereby closing the pressure control valve 4. The tappet element 2 has an elongated tappet body 2a comprising a center axis 2d. A driving device 10 is disposed on a second side 2c. Such a driving device 10 can, for example, be a magnetic drive which, in the active state and on the basis of the depiction in FIGS. 1a, b, moves the tappet element 2 towards the valve ball 6 and thereby presses said valve ball into the valve seat 24. In the case of a conventionally manufactured pressure control valve, the valve body 8a is inserted into the valve housing 8b and fixed there, for example is pressed into the housing or beaded as depicted in FIG. 1b.

Exemplary embodiments of a tappet tip of a conventional pressure control valve are further described with reference to FIGS. 2a, b.

FIG. 2a shows a tappet tip 14 with a substantially planar outer surface or, respectively, end face 22. FIG. 2b shows a recess 12 which is conventionally designed as a circular recess having a defined radius. The tappet tip 14 according to FIG. 2a is thus ground flat, whereas the tappet tip 14 of FIG. 2b has a recess 12 in the form of a ball stamping.

The arrangement of a valve ball 6 on a conventional tappet tip 4 is further illustrated with reference to FIGS. 3a, b.

FIG. 3a shows the original geometry of a planarly ground tappet tip comprising the valve ball, said geometry allowing for a radial tolerance compensation but not being noise-optimized. In this case, the valve ball 6 rests substantially on a point of support on the outer surface 22 of the tappet tip 14. FIG. 3b shows a “ball-in-ball” constellation, which offers noise level advantages, however, causes a change in the axial position due to the spherical surface of the recess when a radial play of the components is compensated. In FIG. 3b, the valve ball 6 stays in the recess 12, wherein the radius of the recess 12, is often designed at least slightly larger than the radius of the valve ball 6. As a result, a substantially punctiform support of the valve ball 6 is also provided on the or, respectively in the, recess 12.

In the case of the planarly ground tappet tip 3a, the valve ball 6 can radially, therefore in FIG. 3a to the left or to the right, swerve without a difference in length in the axial direction occurring and without the transmission of an axial force, in FIG. 3a a force directed downwards, being substantially influenced. In FIG. 3b, the valve ball 6 can in turn also swerve slightly to the left or to the right, thus swerve radially with respect to the center axis 2d, can however, due to the spherical shape of the recess 12, be pulled again onto the center axis 2d when an axial load is applied or, respectively, said valve ball 6 changes the axial position of the tappet tip and thus, e.g., detunes a magnetic circuit of the drive unit when radially displaced.

### SUMMARY OF THE INVENTION

An aspect of the present invention can thus be seen in the fact that a tappet element is provided for a pressure control valve, said tappet element being set up to compensate to a certain extent for inaccuracies or tolerances in the radial direction without changing the axial position.

A tappet element for a pressure control valve, a pressure control valve for a vehicle, in particular an automobile, an engine element for a vehicle as well as a vehicle, in particular an automobile, are thus displayed according to the dependent claims. Preferred embodiments ensue from the dependent claims.

The setting of a defined working point in the magnetic force characteristic diagram is of great importance for the proper functioning of a pressure control valve. During the course of installation, inaccuracies in the actual dimensions of the installed individual parts in the axial direction are compensated by suitable measures. All remaining influences on the axial lengths that occur during operation, for example setting, smoothing out, embedding contours, etc. displace the magnetic working point with respect to the target state established during installation. Minimizing this displacement is therefore an aspect of the invention. A finite guidance accuracy of the components in the radial direction, in particular those of the tappet element of a pressure control valve, should likewise, whenever possible, not have an effect on the axial adjustment. For that reason, valve body, disk as well as the cutout in the valve housing, which accommodates said parts, generally have planar contact surfaces which are perpendicular to the main axis of the valve. In the original implementation of a tappet tip (cf. FIG. 2a), said tappet tip is likewise planarly ground and is therefore perpendicular to the main axis so that a radial play of the tappet element has no effect on the axial lengths. In order to prevent the valve ball from leaving an actual impression in the planar surface or, respectively, the outer surface of the tappet tip and therefore a displacement of the magnetic working point from occurring, during operation, the tappet tip can be stamped prior to installation (cf. FIG. 2b). This stamping than has a somewhat greater diameter than the valve ball and furthermore improves the noise behavior of a pressure control valve. The radial play of the tappet however also acts here in the axial direction due to the circular surface of the recess in the tappet tip, which can undesirably change force ratios in the magnetic circuit.

According to the invention, a tappet element is provided which is designed to equally provide a radial play compensation as well as an optimized noise behavior without creating significant additional costs in the component manufacture and/or installation. When using a tappet element according to the invention, a fit between valve housing and valve body can be designed such that a radial play between the components is minimized within the scope of cost-neutral measures.

According to the invention, the tappet tip is no longer spherical but pre-shaped with a combined geometry such that no axial effects are active within a radial play that is present. As a result, the functions of radial play compensation and noise behavior, which previously acted in opposition to one another, can particularly be combined with one another and optimized.

The recess in the tappet tip has thus a first and a second region. Both regions can be disposed concentrically to one another and particularly with respect to the center axis. In the first region, said recess is formed substantially as a planar surface perpendicular to the center axis or, respectively, to the longitudinal extension direction of the tappet body. Hence, the first region has the possibility of providing the valve ball with a radial compensation respectively a radial movement option without this having an influence on the axial position of the tappet element, or, respectively the tappet tip. The valve ball can thus substantially freely swerve laterally on the planar surface of the first region without the axial position of the tappet element thereby being influenced. A second region which adjoins the first region substantially forms a suitable transition region between the first region and the actual outer surface or end face of the tappet tip. This second region thus forms a suitable transition between the first region and the outer surface. Such a surface design of the second region can thereby, e.g., be configured as an inclined plane, a truncated cone section or as a suitably curved surface, for example the surface of a spherical shape. In so doing, the surface of the second region preferably has a radius that is comparable to the valve ball, if need be likewise slightly larger. The spherical surface can, however, also have a radius that is greater than the radius of the valve ball, in particular that is significantly greater.

In order to initially provide a configuration between the valve body and the valve housing that is free of play, the nominal dimension, not the tolerance, of the outside diameter of the valve body is selected in such a manner that the positive maximum adaptation is 0 mm. The minimum clearance becomes slightly negative, whereby the valve body is to be substantially pressed into the valve housing and thus to always be centrically disposed in the cutout of the valve housing. A check can furthermore be made as to whether a fabrication of the cutout in the valve housing is possible in a clamping operation with the central guide bore, thus can be produced in the same operation step, whereby further radial tolerances at the valve body may be omitted. A radial play which possibly still remains can now be constructively determined and be used as a basis for the geometry of a punching tool for the tappet tip of the tappet element. The first region has thus preferably a dimension which sufficiently compensates for a radial play that is present such that an axial position of the tappet element is not influenced or changed by the radial play.

In a preferred manner, the recess in the tappet tip can now be designed as a combination of a central, circular, planar, flat portion (first region) and a spherical (spheroidal) shape (second region) as the stamped geometry. Such a combination consisting of a plane which is substantially flat and formed, in particular, perpendicularly to the center axis of the tappet element and a spheroidal configuration of the second region is referred to below as a flat round stamped region.

### BRIEF DESCRIPTION OF THE DRAWINGS

Embodiments of the invention are depicted in the drawings and explained in detail in the following description.

In the drawings:

FIGS. 1a and 1b show the schematic design of a conventional pressure control valve ;

FIGS. 2a and 2b show exemplary embodiments of a tappet tip 14 of a conventional pressure control valve;

FIGS. 3a and 3b show the arrangement of a valve ball 6 at a conventional tappet tip 14; and

FIG. 4 shows an exemplary embodiment of the shape of the recess of a tappet tip according to the invention.

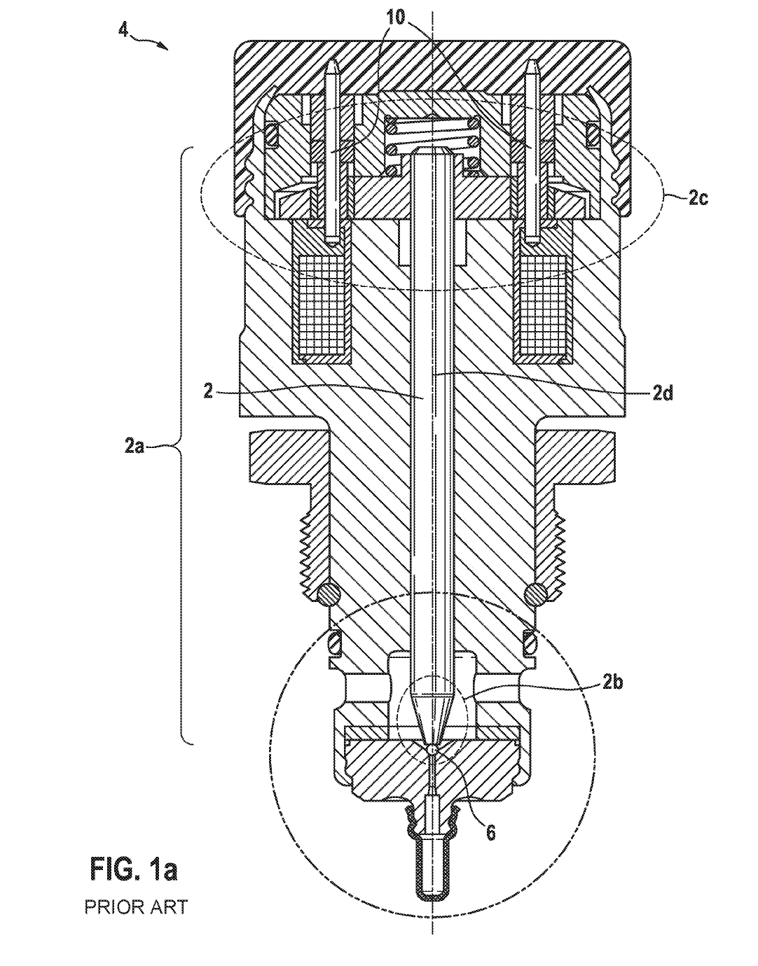

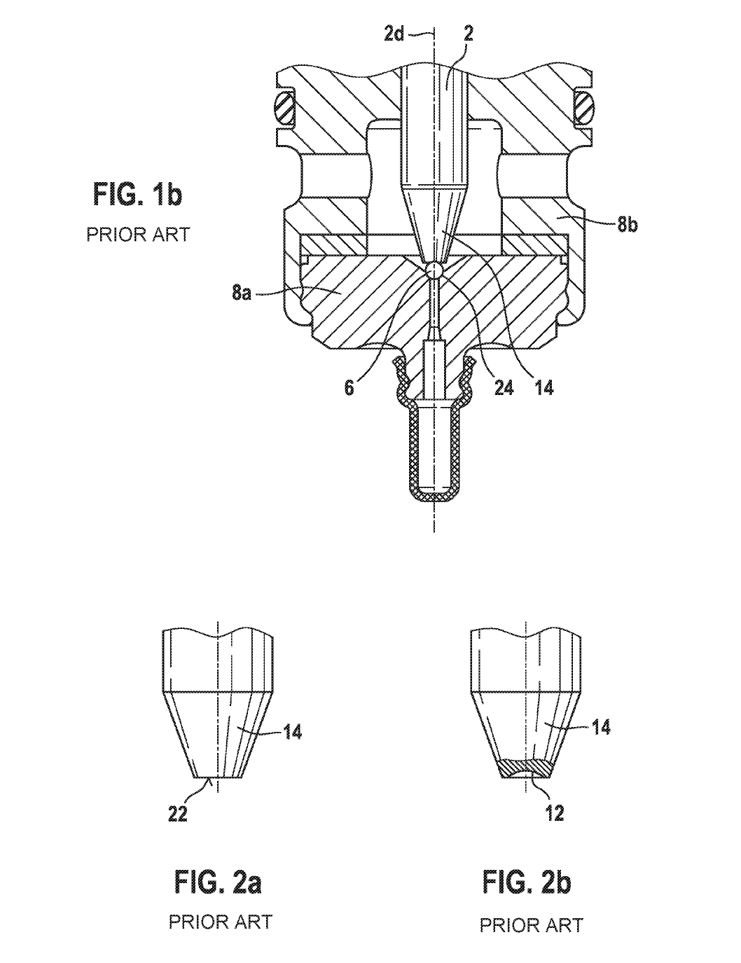

### DETAILED DESCRIPTION

An exemplary embodiment of the shape of the recess of a tappet tip according to the invention is depicted while further referring to FIG. 4.

Tappet tip 14 shows in detail a stamped geometry having a flat round stamped region which is designed in diameter in such a manner that the contact between valve ball and tappet tip 14 in the recess 12 via the remaining radial tolerances remains constantly in the region of the flat portion, therefore in the first region 16a. As a result, a radial movement 20a, substantially a movement 18a that does not influence the axial position of the tappet element 2, along the plane of the region 16a is possible. A second region 16b is disposed outside of this first region 16a, the geometry being continued, by way of example, in a manner comparable to the ball-shaped stamping. This connecting geometry of the second region 16b can, for example, be configured spherically or progressively depending on which boundary conditions of the spherical stamping are to be maintained. A movement which is dependent on the concrete geometrical configuration of the surface of the second region 16b of the recess 12 and which exemplarily, in FIG. 4, has a circular course and therefore describes a movement about a center point with radius R of the recess 12 in the second region 16b thus occurs in the second region 16b. When a movement occurs in the second region 16b, not only a radial movement 20a is thus carried out but a radial movement 20a in combination with a further movement in the axial direction 20b, whereby the axial position of the tappet element and therefore the layout of the driving device 10, in particular a magnetic circuit, changes. The axial position does not however change when a movement takes place in the region 16a. If all tolerances are now designed such that exclusively a movement of the valve ball 6 in the first region 16a is required to compensate for said tolerances, said tolerances can then result for the most part completely without changing the axial position of the tappet element 2 and therefore without a movement in the axial direction 20b.

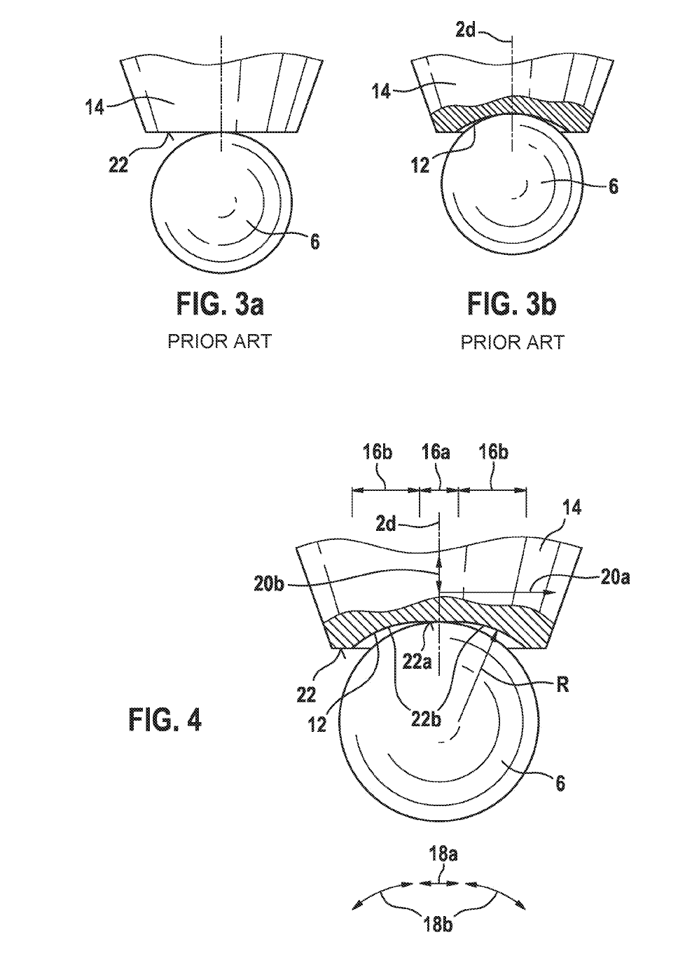

The flat round stamped region is depicted in an exaggerated fashion in FIG. 4, in particular with regard to the fact that a radius of the second region 16b is essentially only slightly different from the radius of the valve ball 6. In the second region 16b, a situation results macroscopically which is comparable to that of the ball-shaped stamping (cf. FIG. 3b), whereby the noise limiting effect and also the anticipated setting of the tappet element are retained. In the region of the radial play of the arrangement, there is, however, no axial effect on account of the flat portion in the region 16a.

1. A tappet element (2), comprising a tappet body (2a), which has a first side (2b), a second side (2c) and a center axis (2d);
wherein a tappet tip (14) is formed on the first side (2b) and is configured to contact a valve ball (6);
wherein the tappet body is configured such that a driving device (10) for the tappet element (2) can be provided on the second side (2c); and
wherein the tappet tip (14) has a recess (12) for contacting a valve ball (6);
characterized in that
the recess (12) has a first region (16a) and a second region (16b), the first and second regions (16a, b) being arranged concentrically with respect to the center axis (2d); and
wherein a valve ball (6) is movable (18a) on a surface (22a) of the recess (12) in essence exclusively in a radial direction (20a) perpendicular to the center axis (2d) in the first region (16a); and
wherein a valve ball (6) is movable (18b) on the surface (22a) of the recess (12) substantially in a combined motion both in the radial direction (20a) and in an axial direction (20b) in the second region (16b).

2. The tappet element according to claim 1,
wherein a play of the tappet body (2a) in a radial direction (20a) can be compensated by the recess (12).

3. The tappet element according to claim 2,
wherein the play in the radial direction (20) can be compensated without substantially changing the axial position of a valve ball (6).

4. The tappet element according to claim 1,
wherein the first region (16a) of the recess (12) is formed as a surface (22a) perpendicular to the center axis (2d); and
wherein the second region (16b) provides a transition region (22b) from the first region (16a) to an outer surface.

5. The tappet element according to claim 1,
wherein the second region (16b) is configured as a region from the group consisting of a linear region that is not perpendicular to the center axis, a partially circular region, a partially oval region, a bent region, a curved region and as a region formed as a flat round stamped region.

6. A pressure control valve (4) for a vehicle, comprising a tappet element (2) according to claim 1.

7. An engine element for a vehicle, comprising a tappet element (2) according to claim 1.

8. A vehicle comprising a tappet element (2) according to claim 1.

9. The tappet element according to claim 1, wherein the tapper body is elongated.

10. The tappet element according to claim 1,
wherein a play of the tappet body (2a) in a radial direction (20a) can be compensated by the first region (16a) of the recess.

11. The tappet element according to claim 2,
wherein the play in the radial direction (20) can be compensated without substantially changing the axial position of a valve ball (6), so that the play in the radial direction (20a) does not substantially influence a position of a valve ball (6) in a valve seat (24).

12. The tappet element according to claim 1,
wherein the first region (16a) of the recess (12) is formed as a surface (22a) perpendicular to the center axis (2d); and
wherein the second region (16b) provides a transition region (22b) from the first region (16a) to an end face (22c) of the tappet tip (14).

13. An engine element for a vehicle, comprising a pressure control valve (4) according to claim 6.
